(19) United States
(12) Patent Application Publication
(10) Pub. No.: US 2017/0252254 A1
(43) Pub. Date: Sep. 7, 2017

(54) ADJUSTABLE MECHANICAL EXOSKELETON, FOR A BIPED ANIMAL WITH IMPAIRED BONE AND MUSCLE

(71) Applicant: UPROBOTS S. de R.I. de C.V., Zapopan, Jalisco (MX)

(72) Inventor: Norberto VELAZQUEZ NINO, Zapopan, Jalisco (MX)

(73) Assignee: UPROBOTS S. de R.I. de C.V., Zapopan, Jalisco (MX)

(21) Appl. No.: 14/438,640

(22) PCT Filed: Sep. 10, 2014
(86) PCT No.: PCT/MX2014/000139

§ 371 Date: Apr. 27, 2015

(51) Int. Cl. A61H 3/00

(52) U.S. Cl. CPC A61H 3/00; A61H 2201/5084; A61H 2201/5061; A61H 2201/1207; A61H 2201/1238; A61H 2201/1664; A61H 2201/165; A61H 2201/1676

(57) ABSTRACT

A mechanical adjustable exoskeleton is disclosed for use by a biped animal with impaired bone and muscle. The exoskeleton has a metallic structure that supports extensible and reducible brackets, patellas between brackets, electric conventional motors of the linear actuator type of 10 and 30 Kg, an insole is provided in the horizontal base back support, and a lower back support. An electric system that composes of a main microprocessor that operates through a communication to all system components. Magnetic sensors of angular and external position, are placed on each patella and include a magnet, a magnetic sensor and a base for the magnet sensor, force sensors on the insoles, and an accelerometer on the back support enable electronic control in real time.

### TECHNICAL FIELD OF INVENTION

The present invention is related to technical fields of electronics and orthopedic medicine, since this provides an adjustable mechanical exoskeleton, for a biped animal, such as a human with problems of muscular and bone mobility.

### INVENTION BACKGROUND

Nowadays, individuals living with muscle weakness, leg paralysis and mainly paraplegia, making them difficult to move, consequently need wheelchairs, walking sticks, crutches or any other similar technology to face their mobility problem. Although, also robotic technologies or exoskeletons for that purpose have been developed, as may be seen in documents of patents below mentioned.

The patent document WO2011127421 details an exoskeleton, configurable to be coupled to first and second leg support at respective joints of the hip, which allow for flexion and extension around the respective hip axes. A counterweight device including an auxiliary mass is connected to the exoskeleton trunk through an actuator device in such a way that the auxiliary mass is extended behind the exoskeleton trunk. A Front load is supported by the exoskeleton through a load bracket device that includes a load shifting device, exclusively for operating powered mechanisms to raise or lower the front load with respect to the exoskeleton trunk. The auxiliary mass may be shifted, selectively with respect the exoskeleton trunk to balance the movement created about the hip axes by the auxiliary mass and the movement created by the downward force of the load in the load bracket device.

The patent document US2010256537 details a control system for a haptic exoskeleton that have: a structure to be coupled to a person; actuators supported by the structure and which may be operated to induce the movement of a series of body joints; and sensors coupled to the body to detect first, indicative sings of intent of movement of the individual. The control system is provided with a phase of regeneration, the control of one position of the joints on the basis of a reference position; a direct feeding phase, the control of the accomplishment presented by the haptic exoskeleton to the person based on the first signs detected, and a combination block combining the end of regeneration phase and direct feeding phase in order to generate an excitation sign to actuators, thus imposing a controlled position to joints.

The document WO2011124781 discloses a system of mechanical joint that may be used for orthosis, exoskeleton, robot and prosthesis, that will have an application in any system to help in the mobility, muscular support, and rehabilitation of motor skills, amplification and reproduction of natural movements. The mechanical system uses as initial base, the movement in the space of a plane formed by two stringers forming a parallelepiped, the join of two different elements, for example in the side of the torso and the other side of the arm. Each link to the ends of the stringers, allowing rotation, at least one of the three axes will be capable of being mounted in a positioning “plane” system to amplify the joint movement.

As may be seen, all current technologies are besides complex, fixed, that is to say are not customized for users, which results in acquiring a unique device for one individual or change the same as the person may grow up or increasing his/her size.

So that, due to foregoing disadvantages, it was developed a mechanical exoskeleton that has, among its advantages the one of being adjustable to the size of any user that has impaired bone and muscle; which I next describe.

### DETAILED DESCRIPTION OF INVENTION

The characteristic details of the present invention are explained clearly in the following description, figures and examples attached to the present, which are mentioned as examples and should not be considered as limiting for the present invention.

### BRIEF DESCRIPTION OF FIGURES

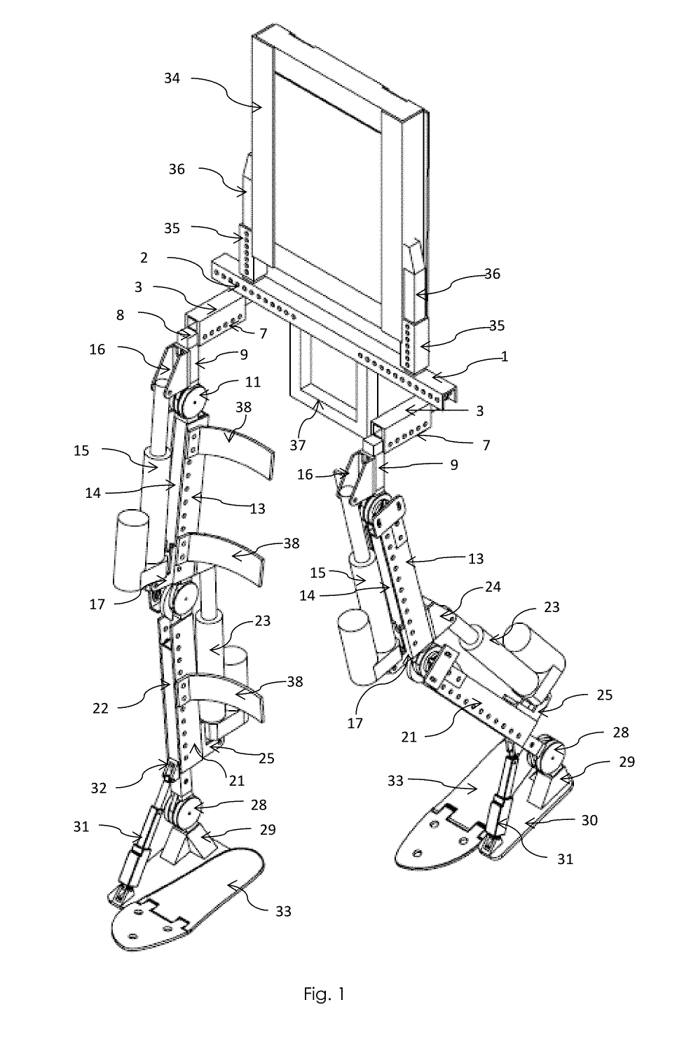

The FIG. 1 is a view in conventional perspective of the mechanical exoskeleton of the present invention.

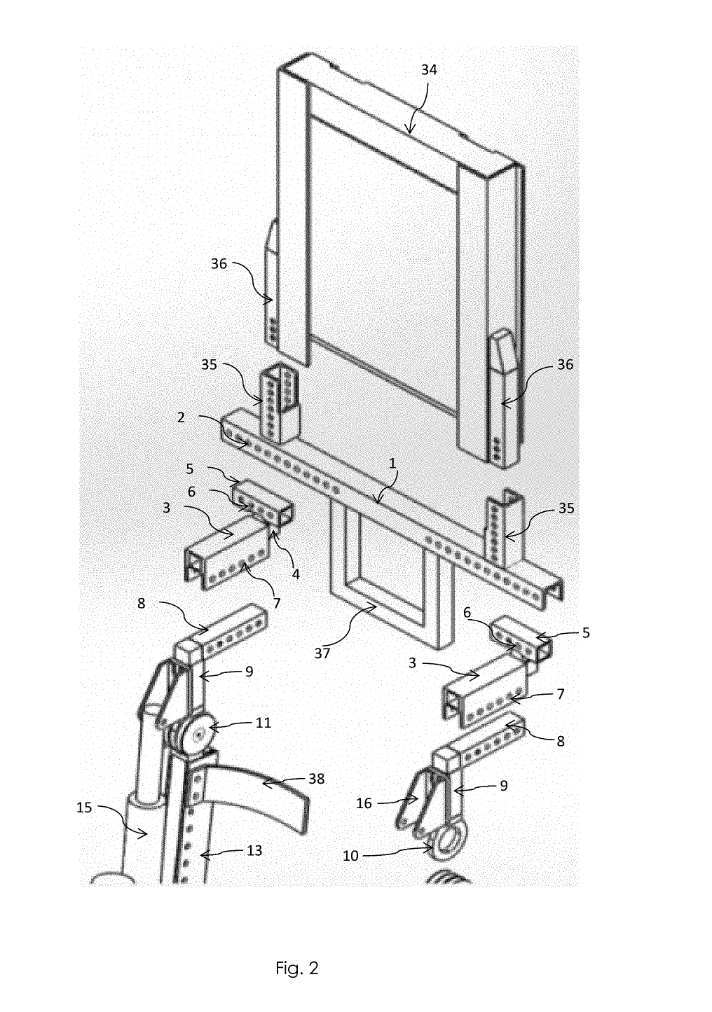

The FIG. 2 is an exploded view of the section of the hip of the present mechanical exoskeleton.

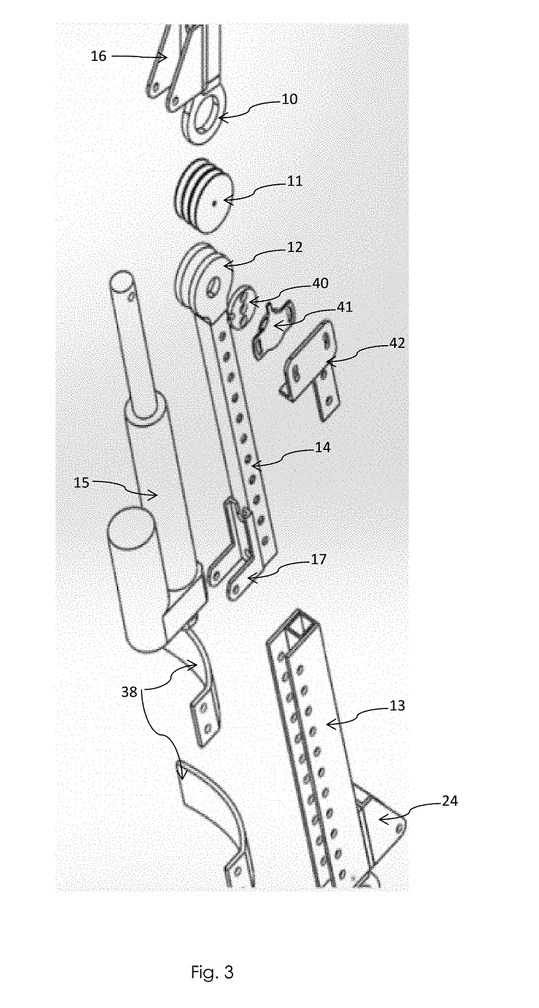

The FIG. 3 is an exploded view of the upper part of one of the lower extremities of said exoskeleton.

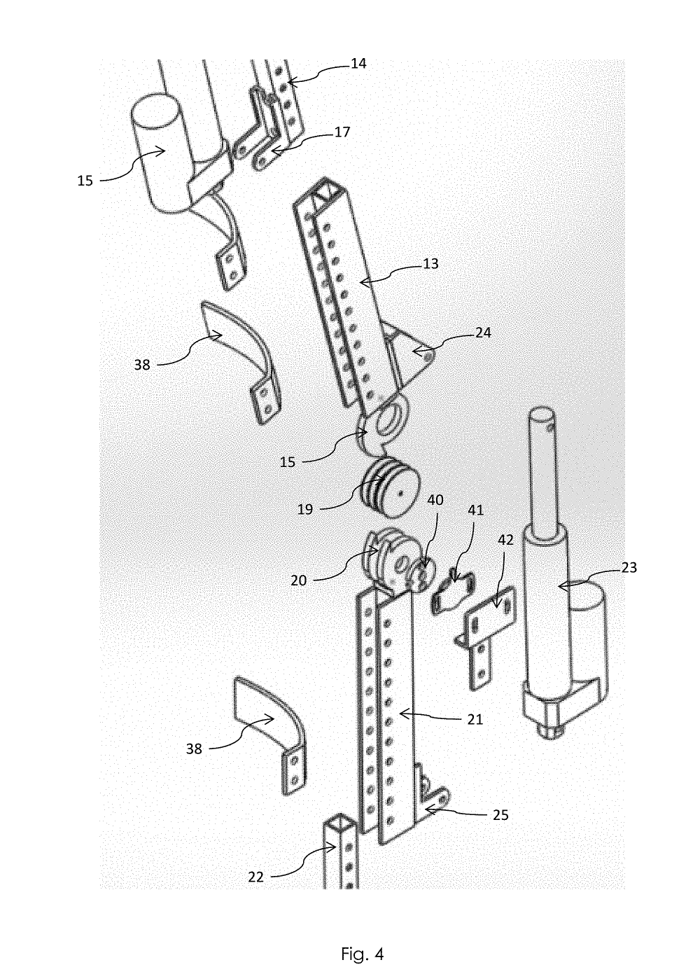

The FIG. 4 is an exploded view of the middle part of one of the ends of the exoskeleton in question.

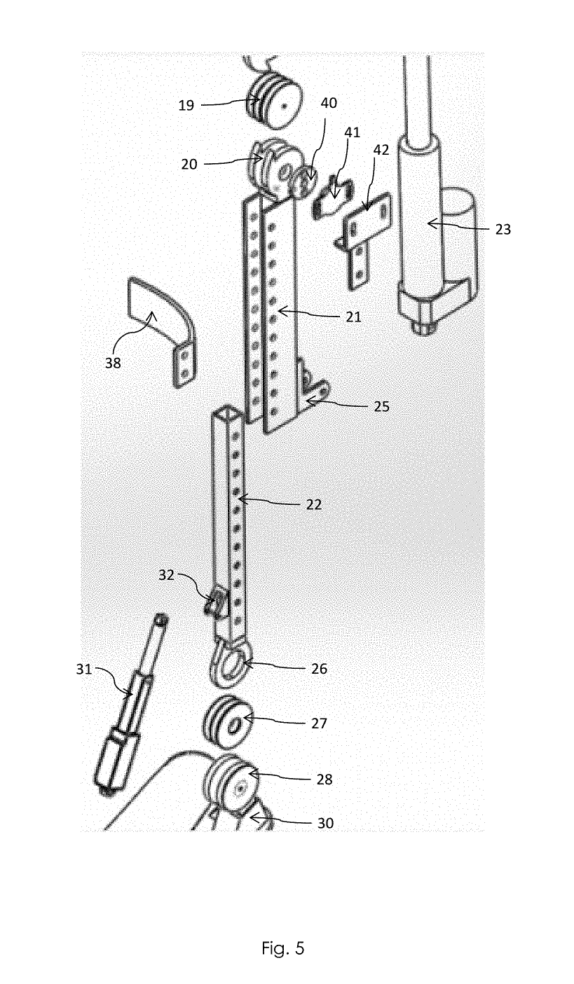

The FIG. 5 is an exploded view of the lower part of one extremity of the exoskeleton.

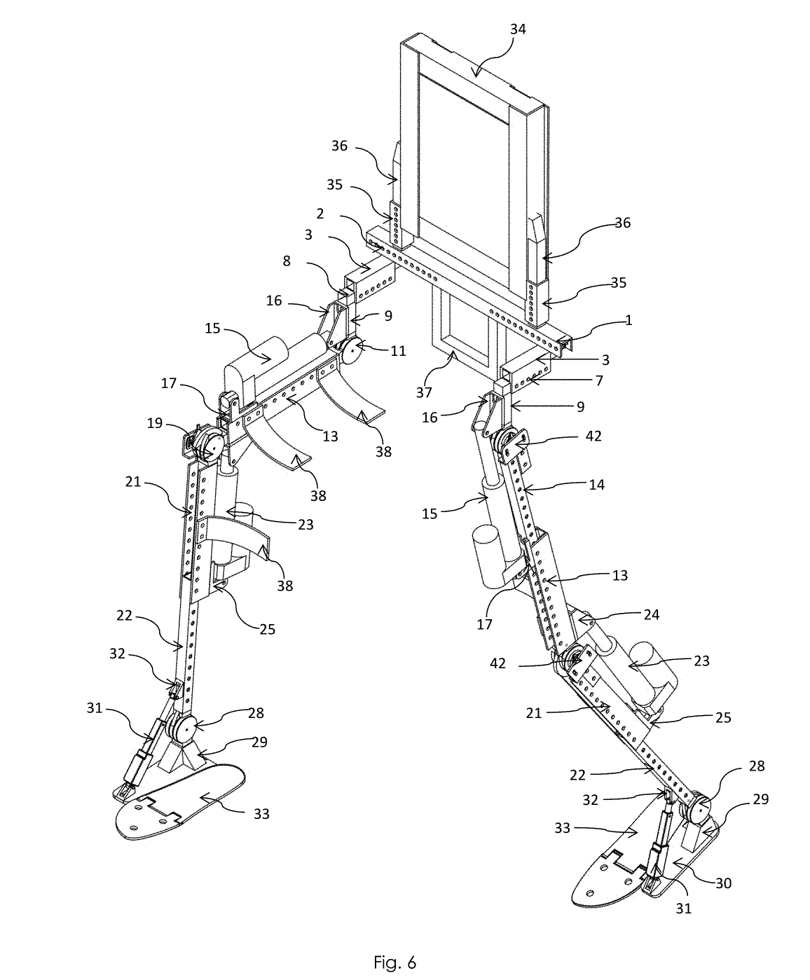

The FIG. 6 is a view in conventional perspective of a mechanical exoskeleton, in an opening position.

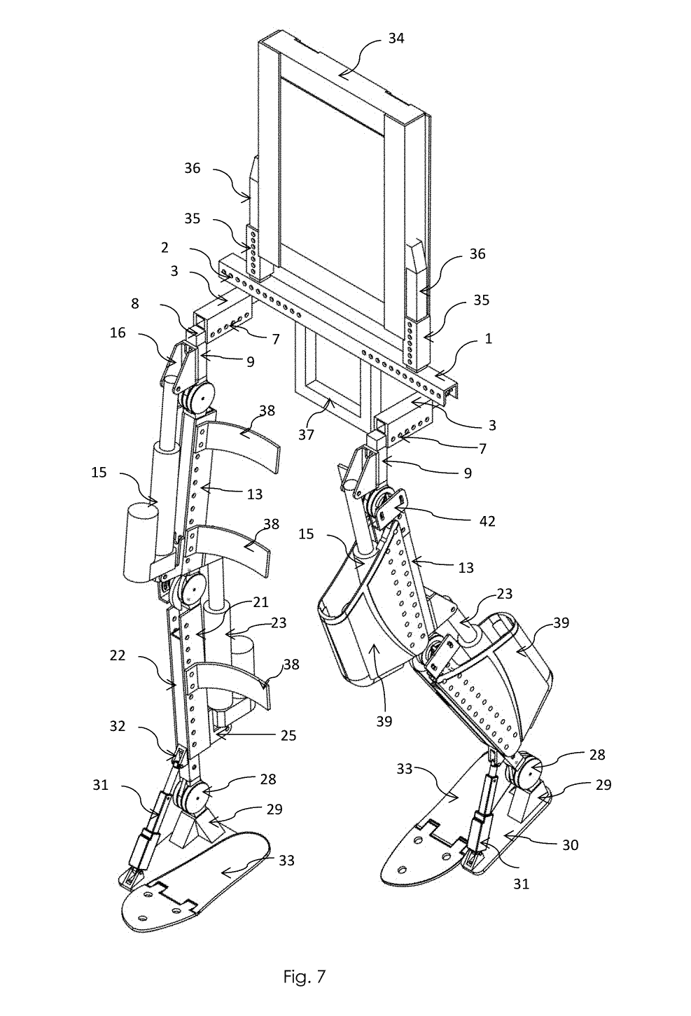

The FIG. 7 is a view in conventional perspective of one of the modalities of the mechanical exoskeleton of the present invention.

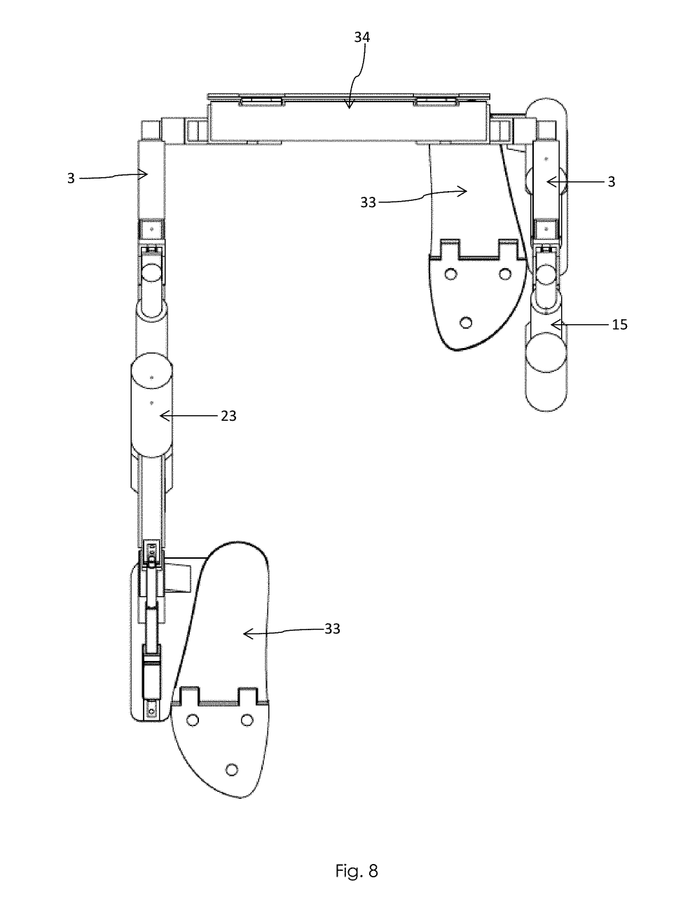

The FIG. 8 is an upper view of the mechanical exoskeleton in question.

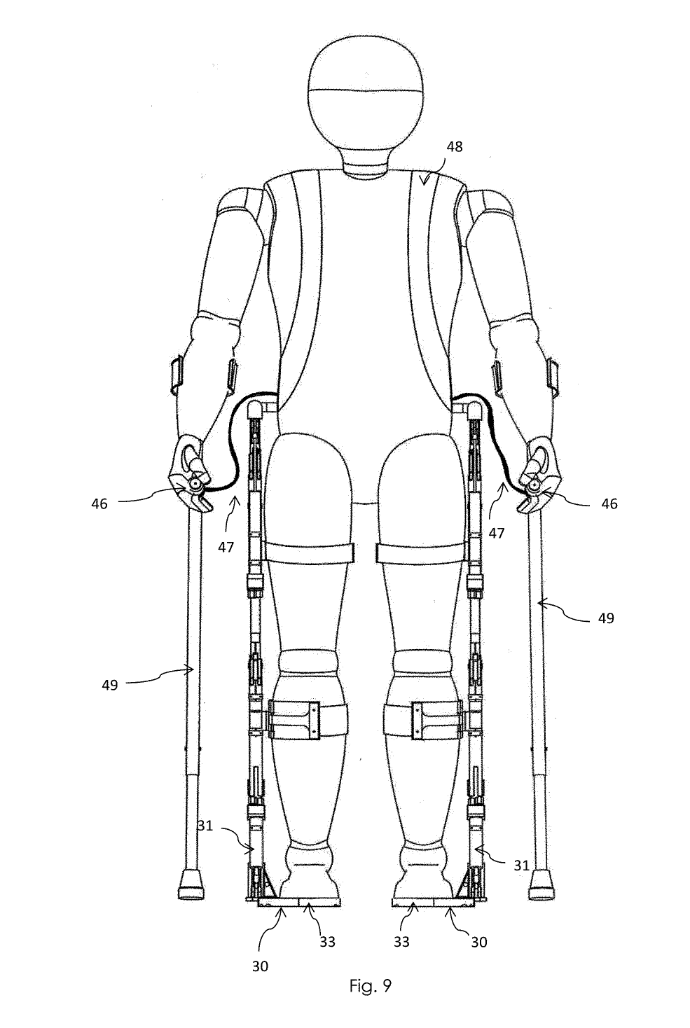

The FIG. 9 is a view in conventional perspective of said exoskeleton in use by a user.

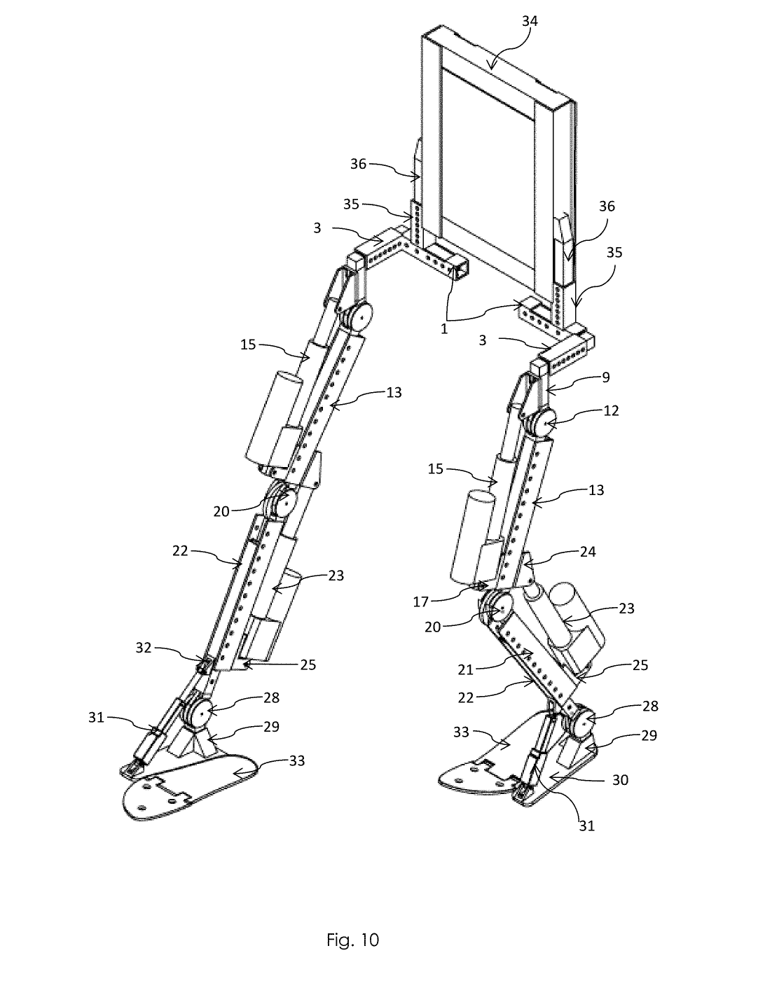

The FIG. 10 is view in conventional perspective of another modality of the present exoskeleton.

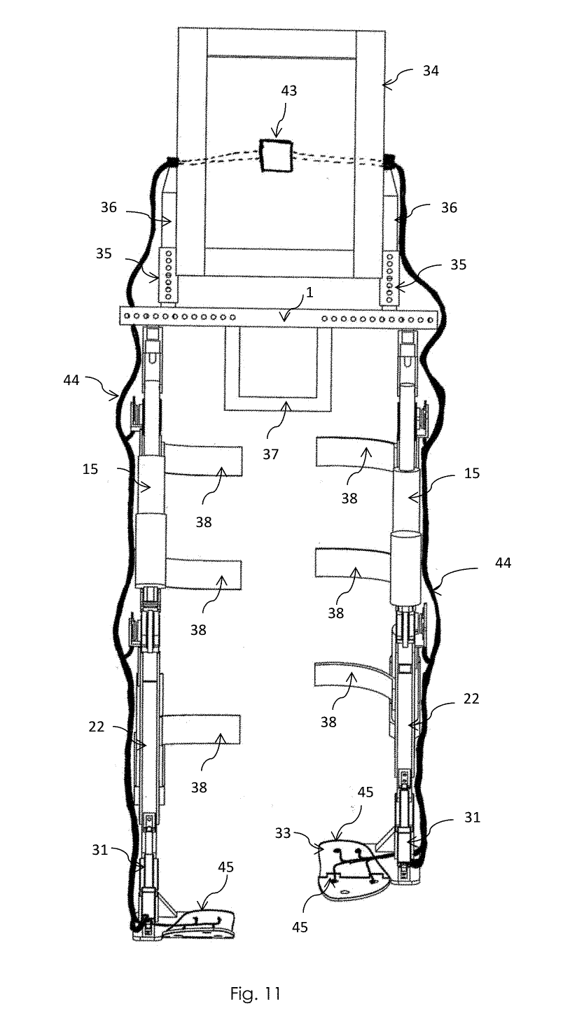

The FIG. 11 is a front view of the mechanical exoskeleton in question, where it is illustrated in a schematic manner, the distribution of the electrical system.

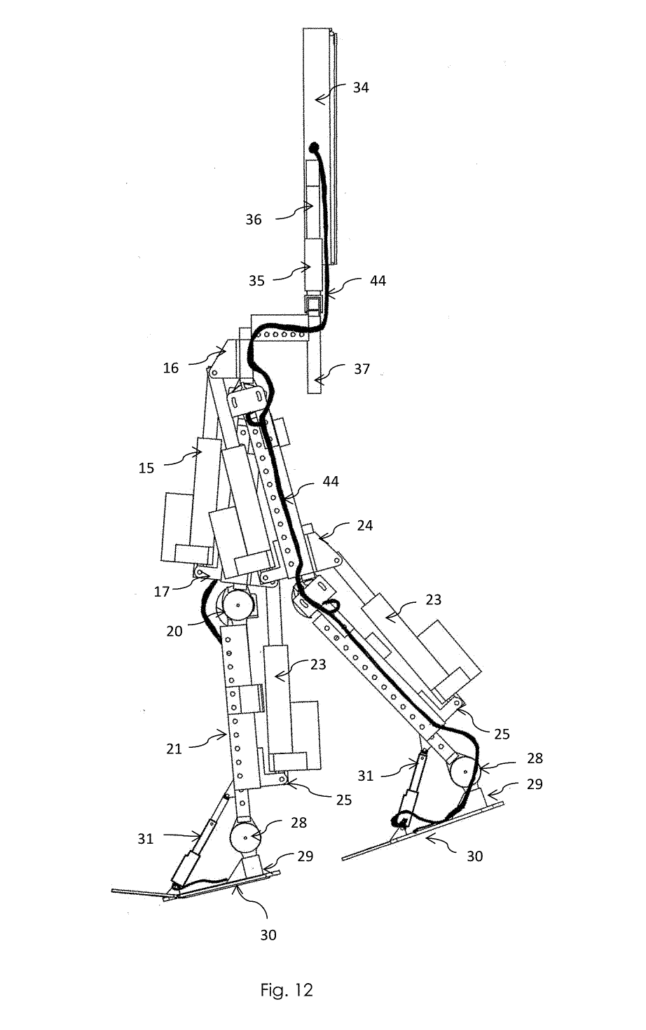

The FIG. 12 is a side view of the mechanical exoskeleton of the FIG. 11.

### EXAMPLE 1

### Preferred Embodiment of the Present Invention

In accordance with the above mentioned figures, the mechanical exoskeleton is composed of a main profile of a square half tube (1), placed face down, which lateral sides have perforations (2) located, linear and preferably toward the ends of said profile. This profile serves as main support of the exoskeleton to adjust the width of the exoskeleton legs and to be adjusted to the user's hip size. Which is achieved thanks to its perforations (2), ensuring that adjustment by means of pins or screws than are introduced in said perforations (2).

On the lower part of the main profile (1), specifically inside its cannel, it is placed horizontally and perpendicularly, with respect to said profile (1), a first pair of extensible and reducible brackets; which are composed of one hollow square tube (3), where its lateral walls extend perpendicularly upward (4), in which it is placed horizontal and perpendicularly, with respect to the tubing (3), a tubular section (5) with perforations (6) on its lateral sides. These tubular sections (5) are introduced and slipped along the main profile channel (1); that sliding is in order to adjust the width of the user's hip and such width is fixed with pins or screws.

On both lateral sides of the hollow tubing (3), are projected downward, welded longitudinally a perforated extension (7) to form in that way a channel below the hollow tube (3), where it is sliding longitudinally a second hollow tube (8) also perforated on its lateral sides that make contact with the perforated extension (7); for which I know, the perforations on both pieces are located at the same height to allow the introduction of a fastening element.

With this pair of extensible and reducible brackets it is possible to adjust the transverse measurement of the user's hip, where the fastening of such measurement is made by means of the introduction of pins or safety bolt in the perforations of the perforated extension (7) and the second hollow tube (8). Also, such pair of brackets supports the lower extremities of the exoskeleton, which in turn support the user's legs.

A vertical bar (9) is fixed perpendicularly on each free end of the second hollow tubes (8), of the first extensible and reducible brackets. At the lower end of each vertical bar (9) there is a ring (10), which, in cooperation with a pair of rings (12), which are welded vertically on the internal upper tube (14), form a first patella or hip patella; where for that purpose a first set of four washers (11) is inserted among the rings (10 and 12) and an internal ball bearing is including for allowing rotation.

Said internal upper tube (14) is square with perforations on its lateral sides, which slides vertically in the channel of a square upper profile (13) of half pipe with perforation on its lateral sides also; where perforations of both pieces (13 and 14) are located in such a way that match each other to allow the introduction of a fastening mean, such as a pin or screw. In this way, both pieces (13 and 14) form a second bracket to support the user's femur, due to its lateral perforation by which it is possible to set the height.

A first conventional electrical motor of linear actuator type of 30 kg F (15), is provided in the front part of each second extensible and reducible bracket. This motor (15) provides the movement force to the exoskeleton extremities and because of the way it is placed is capable of producing a rotating movement in one direction from the linear movement.

To fasten this first motor (15), a first fastening piece (16) is welded in the front part of the vertical bar (9); where said fastening piece (16) is a small square profile of half pipe, with lateral and triangular sides and in its channel is introduced and fastened to the upper end of the first motor (15). While the lower end of the first motor (15) is fastened in a base (17) which is welded in the lower extreme of the internal upper tube.

On the bottom of the upper profile (13) is welded a ring (18), that together with a pair of rings (20) welded on the upper end of a square lower profile (21) of half pipe form a second patella or knee patella, so that a second set of four washers (19) and a ball bearing is placed among said rings (18 and 20) to allow rotation.

In the channel of the square lower profile (21)of half pipe, a lower tube moves vertically (22). These pieces (21 and 22) form a third extensible and reducible bracket that supports the lower part of the user's leg, so that said pieces have the same characteristics and configuration than those of the upper tube (14) and upper profile (13).

A second conventional electrical motor of the linear actuator type of 30 kg F (23) is provided in the rear part of each third extensible and reducible bracket. Said second motor is fastened, its upper part, in a second fastening piece (24), of the same configuration than those of the first fastening piece (16), this second piece (24) is located in the rear lower part of the upper profile (13); and the upper part of the second motor (23) is fastened in a second base (25) located in the lower rear part of the lower profile (21).

On the lower part of each lower tube (22) is welded a ring (26), where a third patella or ankle patella will be formed, together with a pair of rings (28), which is welded to a fixed bracket (29), among the rings (26 and 28) it is inserted a third set of washers (27) and a ball bearing to allow rotation.

The fixed bracket (29) is composed of a metallic bracket that is fastened in a horizontal base (30) and works as base for all the exoskeleton, so that its function is to provide a firm support from the sole of the foot of the exoskeleton to the legs of the same.

A motor type linear actuator of 10 kg F (31) is placed in an sloping manner between the horizontal base (30) and the lower tube (22), where for that purpose is provided a pair of fastening pieces (32 an 32′) where a (32) is fixed in the lower front part of the lower tube (22) and the other one (32′) in the front end of the horizontal base (30). This motor gives the moving force in the ankle joint of the exoskeleton and because of the way this is designed is capable of producing a rotating movement in one direction from the linear movement.

All above mentioned motors may be electrical, hydraulic, electromechanical or pneumatic or any other kind of actuator that generates a linear movement with a force from 10 to higher of 30 kg F.

It should be noted that all patellas, as described previously, include fixed rings with several bronze washers among them to reduce friction and an internal ball bearing that makes possible the rotation; since said patellas has the function of operating as a mechanical joint of a single grade of freedom, and block lateral movements in the hip, knee and ankle joint.

Each patella has externally a magnetic sensor of angular position which comprises of a magnet (40), a magnetic sensor (41) and a base for the magnetic sensor (42). Said magnetic sensor is in communication with the main microprocessor (43), in this case by means of a wire (44), but it can be any other media. The magnetic sensor allows to know in which position are the exoskeleton's legs. With this it is achieved a mechanical joint of one freedom grade and that impedes lateral movements in the hip, knee and ankle joints of the exoskeleton in question.

An insole (33) is provided in the horizontal base (30), which is a rigid surface that may be metallic and where the exoskeleton user places his/her foot. This piece is the one that raises the user's feet when walking or standing up. In the lower base of this (33)there are four pressure sensors (45) to provide information to the main microprocessor (43) of the exoskeleton regarding which side is applying load and so that by means of the ankle actuator to correct the total position of the exoskeleton when is in a rest position or when making a movement.

A back support (34) is provided in the upper part of the main profile (1), where said support is, in this example, a metallic frame that may be of steel and that gives support to the users back. Also works for containing the batteries and electronic circuits that control the exoskeleton motors in order this may walk. In this frame it is also a main microprocessor (43) that controls the logic of movements of the exoskeleton based on the information of the sensors distributed in said exoskeleton.

The back support (34) is seated in a pair of tubular bases (35), which consist, each one, of one tubular profile up to its half, placed vertically with perforations on its lateral sides. In the lateral sides of the back support (34) is it provided a tubular piece (36) with perforations on its sides that make contact with the sides with perforation of the tubular base (35), since said tubular piece is introduced vertically in the tubular base (35); in such a way that allows to adjust the height desired to place the support of the back according to the user's size.

Flexible strips (48) are provided in the front part of the back support (34), for users place the same on his/her chest to be firmly attached to the exoskeleton.

By the central lower part of the main profile (1) it is provided a lower back support (37), which is a frame of profiles, that is padded for giving a firm and soft support to the user's lower back.

The exoskeleton also provides supports for the user's legs, which consist of metallic strips (38) ergonomically appropriate to support a person using the exoskeleton; said strips (38) are fixed horizontally in the internal lateral sides of the upper profiles (13) and lower (21). It is also possible to adapt some fastening straps (not shown) to keep the person attached to the exoskeleton. The number and distribution of strips (38) is according to the user's size.

All pieces conforming the structure of the exoskeleton of the present invention are metallic, preferably of steel; although they may be made of any resistant material and lightweight. Also, said pieces are tubular in order to make said mechanical exoskeleton lighter.

The electrical system of the exoskeleton includes: force sensors (45) in the insoles (33); an accelerometer (not shown) in the backrest (34), positioning sensor on each joint patella; an electronic control in real-time; and the main microprocessor (43) that keeps the exoskeleton balance in a static position.

According to the above mentioned, we obtain a mechanical exoskeleton with auto balance; besides being adjustable for persons of different height, from a children of 1 m to an adult of 1.89 m; likewise, this has an innovative horizontal adjustment that has the advantage that people of different hip sizes can use it.

This adjustment is made in a telescopic manner, and has the function of making possible the interposition of motors without these interfering or collide with each other.

Its auto balance static system corrects lightly the vertical position by means of the motors (31) that the exoskeleton has in its ankles that allows keeping the users standing without the need of using any type of walking stick in a static position. However, said exoskeleton may include, two walking sticks or crutches (49) (see FIG. 9), where a control buttons are placed (46) to manipulate the exoskeleton by part of the user, said control means are communicated by wires (47), although it may communicate in another manner, such a remote via. In the walking stick handle of one of the walking stick it is placed a button to elect the function or activity with regard to getting up, sitting, going up and down stair, walk forward, backward and any other activity desired to make with your legs; while in the walking stick handle of the other walking stick, the button for ordering the exoskeleton to move or stop is placed.

The structure material of the exoskeleton consists mainly of Steel and likewise is composed of six electrical linear motors (15, 23 and 31). In case of require that any joint rotates to generate a movement in the user's leg, the linear actuator motor is activated electronically generating a rotating movement in the desired joint; when all actuators motors operate at the same time a movement controlled by the microprocessor that already have preprogrammed movements (43) is created.

The user may select among different movements preprogrammed which of all them desires to make either stand, sit, walk, going up, going down or bend down.

One of the variants of the present exoskeleton is that motors may have covers (39), such as shown in the FIG. 7, in order to protect the motors from ambient particles that may damage or decrease the performance of the same.

Other variant of the present exoskeleton is that the main profile (1) may be discontinuous or in other words, it may be of two sections of profiles, such as shown in the FIG. 10, in order to make it lighter.

### EXAMPLE2

### The Operation of the Mechanical Exoskeleton of the Present Invention is the Following

Being the exoskeleton in the sitting position on a chair, the users should sit inside the exoskeleton's legs previously adjusted to his/her hip size and legs height, in such a way that metallic strips (38) remain under his/her legs. Once made this, the user should attach, by means of any strap, his/her legs to the exoskeleton, as well as wear the backpack strips (34) as shown in the FIG. 9.

Likewise by strips on the feet (not shown) these should be attached to the base of the feet (30) of the exoskeleton.

Once made this the user will take the control walking sticks (FIG. 9) and by means of two buttons will control the functions that he/she desires to make with the exoskeleton. These functions are getting up, sitting, going up and down stairs, walk forward, walk backward and any other thing he/she desires to do with his/her legs. Likewise by strips on the feet (not shown) these should be attached to the base of the feet (30) of the exoskeleton.

In this way the user with the exoskeleton attached, may get up from the wheelchair as shown in the FIG. 9 and walks again, goes up and down stairs and sits as he/she would do it if he/she had not disability.

When the user is standing with the exoskeleton and is in a vertical position, the microprocessor (43) will control automatically the vertical position of the user measuring the force applied in the force sensors (45) and the information coming from the accelerometer (not shown) located in the backrest of the back (34) of the exoskeleton to maintain in this way the vertical position of the user with the exoskeleton attached by mean of the motors (15), (23) and (31).

In FIGS. 9, 11 and 12 it is shown how the wire harness connects all sensors with the main microprocessor (43), said harness has the sensor wires and feeding wires for motors (15), (23) and (31) and sensors (41) located in joints.

It is important to say that examples of the performance above mentioned, is one of the preferred manners, however, there are many others obvious manner for an expert in the matter of how carrying out the present invention. So that said modifications or variants are included in the present invention.

1. A mechanical adjustable exoskeleton for a biped animal with impaired bone and muscle that includes:
i) a main profile of square half-pipe, placed face down, which lateral sides have perforations located, linear and preferably toward the ends of said profile;
ii) a first pair of extensible and reducible brackets are placed horizontally and perpendicularly in the lower part of the main profile, specifically inside its channel; where each extensible and reducible bracket is compose of a hollow square tube, which lateral walls extend perpendicularly upwards, in which a tubular section with perforations on its lateral sides with respect to the tube are placed horizontal and perpendicularly; said tubular sections are introduced and slipped along the channel of the main profile and are fastened by a fastening element; both lateral sides of the hollow tube are projecting downwardly welding them longitudinally a perforated extension, to form in that way a channel under the hollow tube, where the second hollow tube is slipped longitudinally (also perforated on its lateral sides that make contact with the perforated extension;
iii) a vertical bar is fixed perpendicularly on each free end of the second hollow tubes, and in the lower end of each vertical bar is provided a ring;
iv) a first patella or patella hip is provided in the lower part of each pair of extensible and reducible brackets, which is formed by joining together of the ring, vertical bar, a pair of rings that are welded vertically on the lower end of a upper internal tube, a first set of four washers is inserted among said rings and an internal ball bearing is included to allow the rotation;
v) a second pair of extensible and reducible brackets to support the user's femur is composed of a upper internal tube that has perforations on its lateral side, which is slipped vertically in the channel of a upper profile of half tube with perforations on its lateral side as well; where perforations from both pieces are located in such a way that match each other to allow the introduction of a fastening element;
vi) a first electrical conventional motor of the linear actuator type of 30 Kg F is provided in the front part of each second extensible and reducible bracket to support this first motor, a first fastening piece is welded in the front part of the vertical bar; where said fastening piece is a small square profile of half tube, with triangle lateral sides and in its channel is introduced and fastened the upper end of the first motor, while the lower end of the first motor is fastened in a base welded in the lower end of the internal upper tube;
vii) a second patella or knee patella is provided in the lower part of each second pair of extensible and reducible brackets, which is formed by joining together the ring fastened in the lower part of the upper profile, a pair of rings welded in the upper end of a lower square profile of half tube, a second set of four washers and a ball bearing are inserted between said ring (18 and 20) to allow the rotation;
viii) a third pair of extensible and reducible brackets to support the lower part of the user's leg, each bracket of the third pair is composed of a lower profile that have perforations on its lateral sides, and a lower tube with perforation on its lateral sides, which moves vertically in the lower profile channel, so that, perforations on both pieces are in the lateral sides that make contact each other to introduce in this a mean of fastening;
ix) a second electrical conventional motor of the linear actuator type of 30 Kg F is provided in the rear part of each third extensible and reducible bracket; the upper part of said second motor is fastened in a second fastening piece same than the first fastening piece, but this second piece is located in the lower rear part of the upper profile; and the lower part of the second motor is fastened in a second bracket located in the lower rear part of the lower profile;
x) a third patella or ankle patella is provided in the lower part of the third pair of extensible and reducible bracket, which is formed by joining together the ring welded in the lower part of each lower tube, a pair of rings welded in a fixed bracket, and between the rings it is inserted a third set of washers and a ball bearing to allow the rotation;
xi) a fixed bracket consisting of a metallic bracket fastened in:
xii) a horizontal base and works as base for all the exoskeleton;
xiii) a motor linear actuator type of 10 Kg F is placed in a sloping manner between the horizontal bracket and the lower tube, where for that purpose is provided a pair of fastening pieces where one (32) is fastened in the lower front part of the lower tube (22) and the other one in the front end of the horizontal bracket;
xiv) an insole is provided in the horizontal bracket, which is a rigid surface, where the user place his/her foot;
xv) a back support is provided in the lower part of the main profile, where said support is a metallic frame; the back support is seated in a pair of tubular brackets, which consist, each one, of a tubular profile up to its half, placed vertically with perforations on its lateral sides; in the lateral sides of the back support a tubular piece is provided with perforations on its sides that make contact with perforated sides of the tubular bracket, since said tubular piece is inserted vertically in the tubular bracket, in such a way that allow to adjust and fix the height desired by a fastening mean according to the users size;
xvi) a flexible strips to fastening are provided in the front part of the back support;
xvii) a lower back support is provided in the central lower part of the main profile, which is a frame of profiles; said lower back support is padded to give a firm and soft support to the lower back of user;
xviii) supports for the user's legs consisting of metallic strips ergonomically appropriate to fasten the person using the exoskeleton; said strips are fastened horizontally in the internal lateral sides of the upper profile and lower;
xix) an electrical system consisting of: a main microprocessor that activates by a communication mean all system components; magnetic sensors of angular and external position, which are placed in all the patellas and is formed by a magnet, a magnetic sensor and a bracket for the magnetic sensor; force sensors in the insoles; an accelerometer (not shown) in the support of the back; and an electronic control in real time;
xx) on the base of the exoskeleton a strips are provided to fasten the user's feet in the insole.

2. The mechanical exoskeleton of claim 1, which motors are electric, hydraulic or electromechanical, or pneumatic or any other kind of actuator that generate a linear movement with a force of 10 or higher of 30 kg F.

3. The exoskeleton according to the claim 1, which mean of fastening is a pin or screw.

4. The mechanical exoskeleton according to claim 1, where the number and distribution of metallic strips depends on the user's size.

5. The exoskeleton according to claim 1 includes also, fastening straps (not shown), next to the metallic strips to keep the person attached to the exoskeleton.

6. The exoskeleton in accordance with claim 1, where the mean of communication between the microprocessor and the rest of components of the electric system is a wire.

7. The mechanical exoskeleton, as specified in the claim 1, where the pieces that comprise the exoskeleton structure are metallic and tubular, steel preferably; although these may be made of any resistant material and lightweight.

8. The mechanical exoskeleton of claim 1, that includes also, two walking sticks or crutches, where an electronic control in real time is placed, said means of control are communicated by wires, although these may communicate in other manner, such as remote via; in the handle of one of the walking sticks is places a button to elect the function or activity of getting up, sitting, going up and down stairs, walk forward, walk backwards and any other activity that user desires to make with his/her legs; while in the handle of the other walking stick a button to order the exoskeleton to move or stop is placed.

9. The exoskeleton in accordance with claim 1, that includes also a cover for each one of the motors to cover the same.

10. The exoskeleton according to claim 1, where the main profile is discontinuous or in other words is formed by two sections of profiles.

11. The mechanical exoskeleton according to claim 1, where the human has a height of 1 to 1.89 m; and different hip sizes.
